(19) United States
(12) Patent Application Publication
(10) Pub. No.: US 2024/0413556 A1
(43) Pub. Date: Dec. 12, 2024

(54) ELECTRICAL CONNECTOR AND METHOD FOR MANUFACTURING ELECTRICAL CONNECTOR

(71) Applicant: Sumitomo Electric Industries, Ltd., Osaka (JP)

(72) Inventors: Yasunori ASANO, Osaka-shi (JP); Masaki SUZUKI, Osaka-shi (JP); Tatsuo MATSUDA, Kanuma-shi (JP)

(73) Assignee: Sumitomo Electric Industries, Ltd., Osaka (JP)

(21) Appl. No.: 18/731,947

(22) Filed: Jun. 3, 2024

(30) Foreign Application Priority Data
Jun. 7, 2023 (JP) 2023-094003

(51) Int. Cl. H01R 12/77; H01R 9/22; H01R 43/20

(52) U.S. Cl. CPC H01R 12/775; H01R 9/223; H01R 43/20

(57) ABSTRACT

An electrical connector includes a ferrule, a plurality of first electric wires, and a first lid member. The ferrule includes a front-end surface intersecting a first direction, a first disposition surface parallel to the first direction, and a plurality of first disposition grooves extending along the first direction and formed in the first disposition surface in such a manner as to be arranged along a second direction intersecting the first direction. The plurality of first electric wires are disposed in the plurality of first disposition grooves. The first lid member is disposed on the first disposition surface. The first lid member covers the plurality of first electric wires disposed in the plurality of first disposition grooves.

### TECHNICAL FIELD

The present disclosure relates to an electrical connector and a method for manufacturing the electrical connector. The present application claims priority based on Japanese Patent Application No. 2023-094003 filed on Jun. 7, 2023, the entire contents of which are incorporated herein by reference.

### BACKGROUND

Japanese Unexamined Patent Publication No. 2017-069166 discloses an electrical connector including a plurality of electric wires. The plurality of electric wires of the electrical connector described in Japanese Unexamined Patent Publication No. 2017-069166 are held by a housing in a state of being adjacent to each other.

### SUMMARY

An electrical connector of the present disclosure includes a ferrule including a front-end surface intersecting a first direction, a first disposition surface parallel to the first direction, and a plurality of first disposition grooves extending along the first direction and formed on the first disposition surface in such a manner as to be arranged along a second direction intersecting the first direction, a plurality of first electric wires disposed in the plurality of first disposition grooves, and a first lid member disposed on the first disposition surface, wherein the first lid member covers the plurality of first electric wires disposed in the plurality of first disposition grooves.

### BRIEF DESCRIPTION OF THE DRAWINGS

FIG. 1 is a front view of an electrical connector according to an embodiment;

FIG. 2 is a plan view of the electrical connector illustrated in FIG. 1;

FIG. 3 is a rear view of the electrical connector illustrated in FIG. 1;

FIG. 4 is a partially enlarged view of the electrical connector illustrated in FIG. 3;

FIG. 5 is a sectional view of the electrical connector taken along the line V-V illustrated in FIG. 4;

FIG. 6 is a flow chart of a method for manufacturing the electrical connector illustrated in FIG. 1; and

FIG. 7 is a sectional view of an electrical connector according to a modification.

### DETAILED DESCRIPTION

### Problems to be Solved by Present Disclosure

The housing of the electrical connector described in Japanese Unexamined Patent Publication No. 2017-069166 may have a disposition surface in which a disposition groove for guiding the electric wire to a front-end surface of the housing is formed. However, when the electric wire is disposed in the disposition groove, a non-uniform dielectric constant distribution is formed around the electric wire, and thus, there is a possibility that the communication performance deteriorates due to impedance mismatch.

### Effects of Present Disclosure

According to the present disclosure, it is possible to provide an electrical connector and a method for manufacturing the electrical connector capable of suppressing deterioration in communication performance.

### Description of Embodiments of Present Disclosure

First, contents of embodiments of the present disclosure will be listed and described.

An electrical connector of the present disclosure is (1) “an electrical connector including a ferrule including a front-end surface intersecting a first direction, a first disposition surface parallel to the first direction, and a plurality of first disposition grooves extending along the first direction and formed on the first disposition surface in such a manner as to be arranged along a second direction intersecting the first direction, a plurality of first electric wires disposed in the plurality of first disposition grooves, and a first lid member disposed on the first disposition surface, wherein the first lid member covers the plurality of first electric wires disposed in the plurality of first disposition grooves”.

In the electrical connector according to (1), the ferrule includes a plurality of first disposition grooves, and the plurality of first electric wires are disposed in the plurality of first disposition grooves. This makes it possible to guide the plurality of first electric wires to the front-end surface in a state of being disposed in the plurality of first disposition grooves. Moreover, since the first lid member is disposed on the first disposition surface in such a manner as to cover the plurality of first electric wires, the non-uniformity of the dielectric constant distribution around the plurality of first electric wires is suppressed as compared with, for example, a case where a region of the plurality of first electric wires on the side opposite to the plurality of first disposition grooves is exposed to air. This makes is possible to suppress deterioration in communication performance due to impedance mismatch. Therefore, according to the electrical connector, it is possible to suppress deterioration in communication performance.

The electrical connector of the present disclosure may be (2) “the electrical connector according to (1), further including a plurality of second electric wires and a second lid member, wherein the ferrule further includes a second disposition surface facing a side opposite to the first disposition surface, and a plurality of second disposition grooves extending along the first direction and formed in the second disposition surface in such a manner as to be arranged along the second direction, the plurality of second electric wires are disposed in the plurality of second disposition grooves, and the second lid member is disposed on the second disposition surface in such a manner as to cover the plurality of second electric wires disposed in the plurality of second disposition grooves”. This makes it possible to guide the plurality of second electric wires to the front-end surface in a state of being disposed in the plurality of second disposition grooves. Moreover, since the second lid member is disposed on the second disposition surface in such a manner as to cover the plurality of second electric wires, the non-uniformity of the dielectric constant distribution around the plurality of second electric wires is suppressed as compared with, for example, a case where a region of the plurality of second electric wires on the side opposite to the plurality of second disposition grooves is exposed to air. This makes is possible to suppress deterioration in communication performance due to impedance mismatch.

The electrical connector of the present disclosure may be (3) “the electrical connector according to (2), wherein the ferrule further includes a plurality of first insertion holes communicating with the plurality of first disposition grooves and opening to the front-end surface, and a plurality of second insertion holes communicating with the plurality of second disposition grooves and opening to the front-end surface, the plurality of first electric wires are inserted into the plurality of first insertion holes, and the plurality of second electric wires are inserted into the plurality of second insertion holes”. This configuration secures the positional accuracy of the first electric wires and secures the positional accuracy of the second electric wires.

The electrical connector of the present disclosure may be (4) “the electrical connector according to (2), wherein the plurality of first disposition grooves and the plurality of second disposition grooves extend to the front-end surface”. This makes it possible to guide the first electric wire to the front-end surface in a state of being disposed in the first disposition groove and to guide the second electric wire to the front-end surface in a state of being disposed in the second disposition groove.

The electrical connector of the present disclosure may be (5) “the electrical connector according to any one of (2) to (4), wherein a dielectric constant of each of the first lid member and the second lid member is the same as a dielectric constant of the ferrule”. This reliably suppresses the non-uniformity of the dielectric constant distribution around the plurality of first electric wires and reliably suppresses the non-uniformity of the dielectric constant distribution around the plurality of second electric wires.

The electrical connector of the present disclosure may be (6) “the electrical connector according to any one of (2) to (5), wherein the plurality of first electric wires are a plurality of electric wires of a first flexible flat cable, and the plurality of second electric wires are a plurality of electric wires of a second flexible flat cable”. This makes it possible to suppress deterioration in communication performance of the first flexible flat cable and the second flexible flat cable.

A method for manufacturing an electrical connecter of the present disclosure is (7) “a method for manufacturing an electrical connecter, the method including a first step of preparing a ferrule including a front-end surface intersecting a first direction, a first disposition surface parallel to the first direction, a plurality of first disposition grooves extending along the first direction and formed on the first disposition surface in such a manner as to be arranged along a second direction intersecting the first direction, a second disposition surface facing a side opposite to the first disposition surface, and a plurality of second disposition grooves extending along the first direction and formed on the second disposition surface in such a manner as to be arranged along the second direction, a second step of disposing a plurality of first electric wires in the plurality of first disposition grooves and guiding the plurality of first electric wires to the front-end surface, a third step of inverting the ferrule, a fourth step of disposing a plurality of second electric wires in the plurality of second disposition grooves and guiding the plurality of second electric wires to the front-end surface, a fifth step of disposing a first lid member on the first disposition surface in such a manner as to cover the plurality of first electric wires, and a sixth step of disposing a second lid member on the second disposition surface in such a manner as to cover the plurality of second electric wires”.

In the method for manufacturing an electrical connector according to (7), in the second step, the plurality of first electric wires are disposed in the plurality of first disposition grooves and the plurality of first electric wires are guided to the front-end surface, in the third step, the ferrule is reversed, and in the fourth step, the plurality of second electric wires are disposed in the plurality of second disposition grooves and the plurality of second electric wires are guided to the front-end surface. This makes it possible to easily guide the plurality of first electric wires and the plurality of second electric wires to the front-end surface. Further, in the fifth step, the first lid member is disposed on the first disposition surface in such a manner as to cover the plurality of first electric wires, and in the sixth step, the second lid member is disposed on the second disposition surface in such a manner as to cover the plurality of second electric wires. With this configuration, as described above, the non-uniformity of the dielectric constant distribution around the plurality of first electric wires and the plurality of second electric wires is suppressed, and thus the deterioration in communication performance due to impedance mismatch is suppressed. Therefore, according to the method for manufacturing an electrical connector, it is possible to suppress deterioration in communication performance.

### Details of Embodiment of Present Disclosure

A specific example of a connector structure of the present disclosure will be described below with reference to the drawings. The present disclosure is not limited to these examples, but is indicated by the claims, and is intended to include all modifications within the meaning and scope equivalent to the claims. In the description of the drawings, the same elements are denoted by the same reference signs, and redundant description will be omitted.

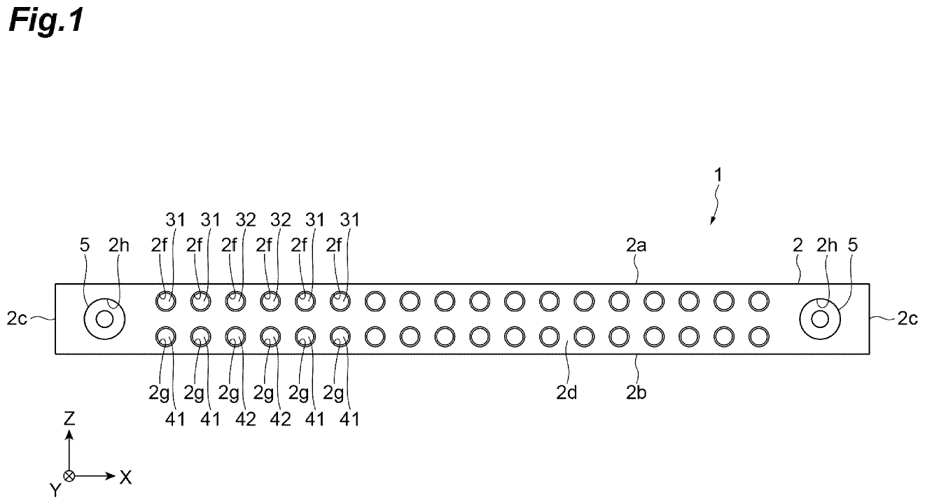

FIG. 1 is a front view of an electrical connector according to the present embodiment.

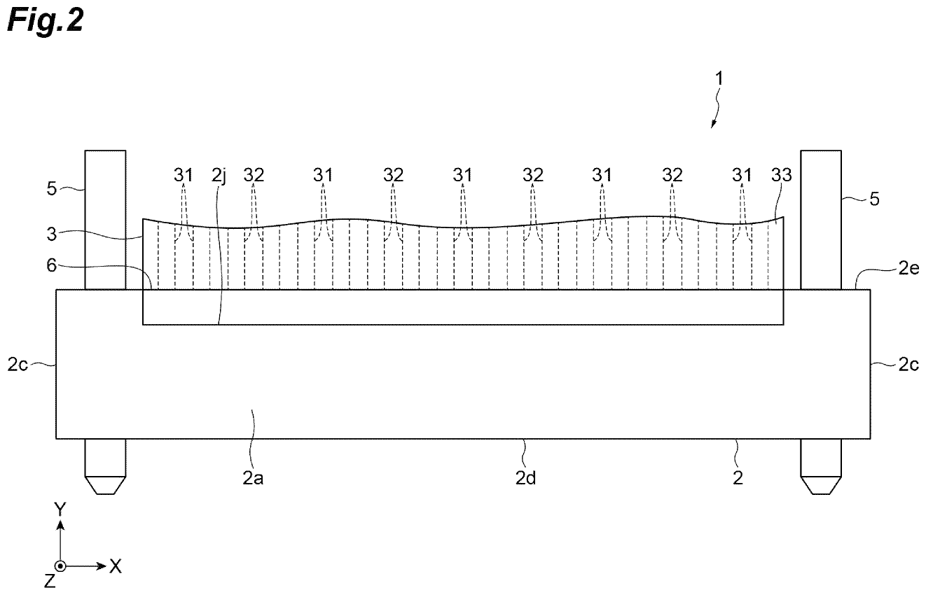

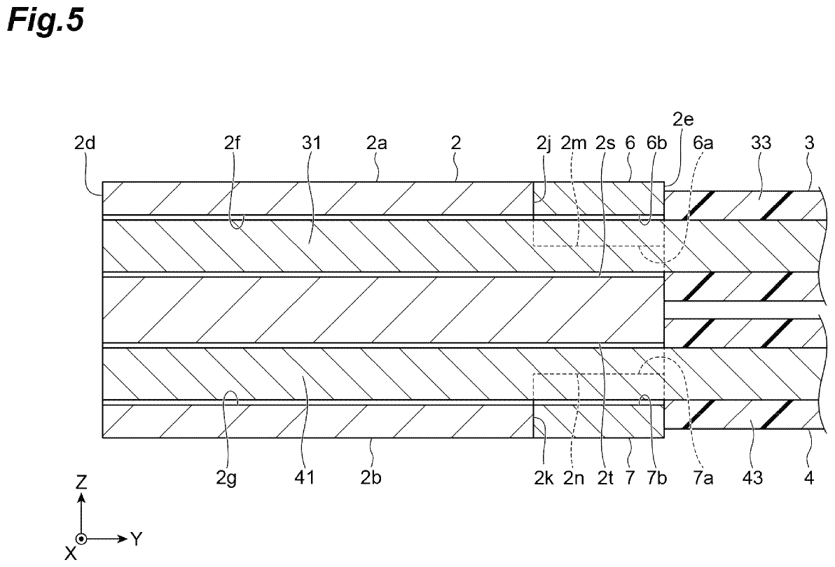

FIG. 2 is a plan view of the electrical connector illustrated in FIG. 1; As illustrated in FIG. 1 and FIG. 2, an electrical connector 1 includes a ferrule 2, a first cable 3, a second cable 4 (see FIG. 5), and a pair of positioning pins 5.

The ferrule 2 includes a first main surface 2a, a second main surface 2b, a pair of side surfaces 2c, a front-end surface 2d, and a rear-end surface 2e. Each of the first main surface 2a and the second main surface 2b is a flat surface intersecting a Z-axis direction. The second main surface 2b faces the side opposite to the first main surface 2a. The side surface 2c is a flat surface intersecting an X-axis direction. The pair of side surfaces 2c face opposite sides to each other. Each of the front-end surface 2d and the rear-end surface 2e is a flat surface intersecting a Y-axis direction (first direction). The rear-end surface 2e faces the side opposite to the front-end surface 2d.

The ferrule 2 includes a plurality of first insertion holes 2f arranged along the X-axis direction when viewed from the Y-axis direction, and a plurality of second insertion holes 2g arranged along the X-axis direction when viewed from the Y-axis direction. The first insertion hole 2f extends along the Y-axis direction and is open to the front-end surface 2d. The plurality of second insertion holes 2g are located adjacent to the plurality of first insertion holes 2f in the Z-axis direction when viewed from the Y-axis direction. The second insertion hole 2g extends along the Y-axis direction and is open to the front-end surface 2d. Each of the first insertion hole 2f and the second insertion hole 2g has, for example, a circular shape when viewed from the Y-axis direction.

The ferrule 2 includes a pair of through holes 2h. The pair of through holes 2h are located on both sides of the plurality of first insertion holes 2f and the plurality of second insertion holes 2g in the X-axis direction when viewed from the Y-axis direction. The through hole 2h penetrates the ferrule 2 in the Y-axis direction and is open in each of the front-end surface 2d and the rear-end surface 2e. The ferrule 2 is symmetrical with respect to a center line parallel to the Z-axis direction and a center line parallel to the X-axis direction when viewed from the Y-axis direction.

Each positioning pin 5 is inserted into a corresponding through hole 2h. In the present embodiment, the positioning pin 5 is press-fitted into the through hole 2h, for example. The front end of the positioning pin 5 protrudes from the front-end surface 2d of the ferrule 2. The rear end of the positioning pin 5 protrudes from the rear-end surface 2e of the ferrule 2. The ferrule 2 is positioned with respect to a mating connector by the pair of positioning pins 5. Specifically, the ferrule 2 is connected to the mating connector such that the positioning pin 5 is inserted into a positioning hole of the mating connector.

The first cable 3 is, for example, a flexible flat cable (FFC). The first cable 3 includes a plurality of electric wires (first electric wires) 31, a plurality of electric wires (first electric wires) 32, and a cover 33. In the present embodiment, two electric wires 31 adjacent to each other and two electric wires 32 adjacent to each other are alternately arranged along the X-axis direction. The cover 33 bundles the plurality of electric wires 31 and the plurality of electric wires 32. Tip portions of the electric wire 31 and the electric wire 32 are disposed in the first insertion hole 2f in a state of being exposed from the cover 33. Tips of the electric wire 31 and the electric wire 32 reach the front-end surface 2d of the ferrule 2. The electric wire 31 functions as, for example, a working electrode. The electric wire 32 functions as, for example, a ground electrode.

Similarly to the first cable 3, the second cable 4 (see FIG. 5) is, for example, a flexible flat cable (FFC). The second cable 4 includes a plurality of electric wires (second electric wires) 41, a plurality of electric wires (second electric wires) 42, and a cover 43 (see FIG. 5). In the present embodiment, two electric wires 41 adjacent to each other and two electric wires 42 adjacent to each other are alternately arranged along the X-axis direction. Two electric wires 31 of the first cable 3 and two electric wires 41 of the second cable 4 are arranged along the Z-axis direction. Two electric wires 32 of the first cable 3 and two electric wires 42 of the second cable 4 are arranged along the Z-axis direction. The cover 43 bundles the plurality of electric wires 41 and the plurality of electric wires 42. Tip portions of the electric wire 41 and the electric wire 42 are disposed in the second insertion hole 2g in a state of being exposed from the cover 43. Tips of the electric wire 41 and the electric wire 42 reach the front-end surface 2d of the ferrule 2. The electric wire 41 functions as, for example, a ground electrode. The electric wire 42 functions as, for example, a working electrode.

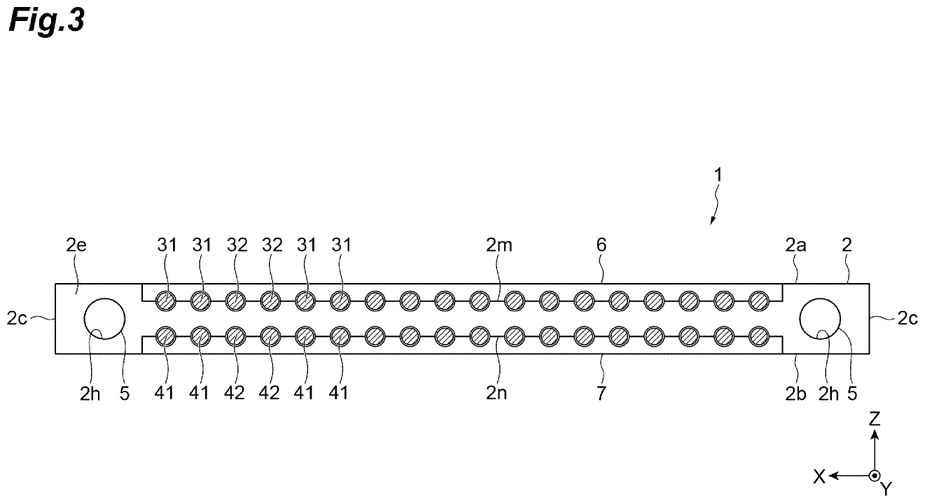

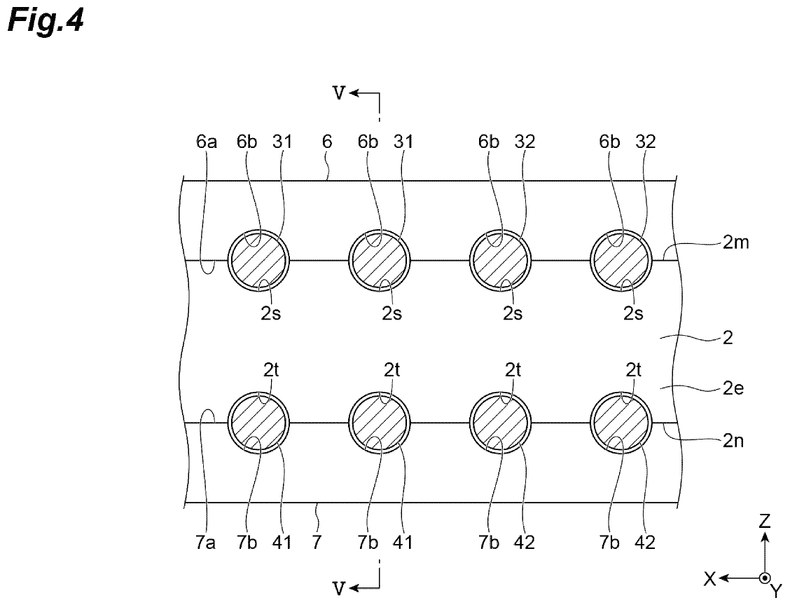

FIG. 3 is a rear view of the electrical connector 1 illustrated in FIG. 1. FIG. 4 is a partially enlarged view of the electrical connector 1 illustrated in FIG. 3. FIG. 5 is a sectional view of the electrical connector 1 taken along the line V-V illustrated in FIG. 4. In FIGS. 3 and 4, illustration of the cover 23 of the first cable 3 and the cover 43 of the second cable 4 is omitted.

As illustrated in FIGS. 3 to 5, the ferrule 2 includes a first disposition surface 2m, a second disposition surface 2n, a plurality of first disposition grooves 2s, and a plurality of second disposition grooves 2t. The first disposition surface 2m is a flat surface that intersects the Z-axis direction and is parallel to the Y-axis direction. The first disposition surface 2m faces the same direction as the first main surface 2a, and is recessed more than the first main surface 2a. The first disposition surface 2m reaches the rear-end surface 2e. The first disposition surface 2m and the first main surface 2a are connected by a first connection surface 2j. The first connection surface 2j is a flat surface intersecting the Y-axis direction.

The plurality of first disposition grooves 2s are formed on the first disposition surface 2m. The plurality of first disposition grooves 2s are arranged along the X-axis direction (second direction intersecting the first direction). The first disposition groove 2s extends along the Y-axis direction and is open to the rear-end surface 2e. The first disposition groove 2s has, for example, a semicircular shape when viewed from the Y-axis direction. The interval between the first disposition grooves 2s adjacent to each other is the same as the interval between the first insertion holes 2f adjacent to each other. The first disposition groove 2s communicates with the first insertion hole 2f. When viewed from the Y-axis direction, the axis line of the first disposition groove 2s overlaps with the axis line of the first insertion hole 2f. The first disposition groove 2s is open in the same direction as the first disposition surface 2m. Tip portions of the electric wire 31 and the electric wire 32 are disposed in the first disposition groove 2s and the first insertion hole 2f in a state of being exposed from the cover 33. Each of the electric wire 31 and the electric wire 32 is guided by the first disposition groove 2s and then inserted into the first insertion hole 2f.

The second disposition surface 2n is a flat surface that intersects the Z-axis direction and is parallel to the Y-axis direction. The second disposition surface 2n faces the same direction as the second main surface 2b, and is recessed more than the second main surface 2b. The second disposition surface 2n faces the side opposite to the first disposition surface 2m. The second disposition surface 2n reaches the rear-end surface 2e. The second disposition surface 2n and the second main surface 2b are connected by a second connection surface 2k. The second connection surface 2k is a flat surface intersecting the Y-axis direction.

The plurality of second disposition grooves 2t are formed on the second disposition surface 2n. The plurality of second disposition grooves 2t are arranged along the X-axis direction. The second disposition groove 2t extends along the Y-axis direction and is open to the rear-end surface 2e. The second disposition groove 2t has, for example, a semicircular shape when viewed from the Y-axis direction. The interval between the second disposition grooves 2t adjacent to each other is the same as the interval between the second insertion holes 2g adjacent to each other. The second disposition groove 2t communicates with the second insertion hole 2g. When viewed from the Y-axis direction, the axis line of the second disposition groove 2t overlaps with the axis line of the second insertion hole 2g. The second disposition groove 2t is open in the same direction as the second disposition surface 2n. Tip portions of the electric wire 41 and the electric wire 42 are disposed in the second disposition groove 2t and the second insertion hole 2g in a state of being exposed from the cover 43. Each of the electric wire 41 and the electric wire 42 is guided by the second disposition groove 2t and then inserted into the second insertion hole 2g.

The electrical connector 1 includes a first lid member 6 and a second lid member 7. The first lid member 6 is disposed on the first disposition surface 2m. The first lid member 6 covers the plurality of electric wires 31 and the plurality of electric wires 32 disposed in the plurality of first disposition grooves 2s. Specifically, the first lid member 6 has, for example, a plate shape. The first lid member 6 includes a first facing surface 6a and a plurality of first facing grooves 6b. The first facing surface 6a is a flat surface intersecting the Z-axis direction. The first facing surface 6a faces the first disposition surface 2m. When viewed from the Z-axis direction, the first facing surface 6a overlaps with the plurality of first disposition grooves 2s. When viewed from the Z-axis direction, the outer edge of the first facing surface 6a overlaps with the outer edge of the first disposition surface 2m.

The plurality of first facing grooves 6b are formed on the first facing surface 6a. The plurality of first facing grooves 6b are arranged along the X-axis direction. The first facing groove 6b extends along the Y-axis direction and is open to both end surfaces of the first lid member 6 in the Y-axis direction. The first facing groove 6b has, for example, a semicircular shape when viewed from the Y-axis direction. The interval between the first facing grooves 6b adjacent to each other is the same as the interval between the first disposition grooves 2s adjacent to each other. The first facing groove 6b is open in the same direction as the first facing surface 6a. The first facing groove 6b and the first disposition groove 2s are plane-symmetrical with respect to a plane parallel to the XY plane. Tip portions of the electric wire 31 and the electric wire 32 are disposed in a space formed by the first disposition groove 2s and the first facing groove 6b in a state of being exposed from the cover 33. That is, the tip portions of the electric wire 31 and the electric wire 32 are covered with the ferrule 2 and the first lid member 6.

The second lid member 7 is disposed on the second disposition surface 2n. The second lid member 7 covers the plurality of electric wires 41 and the plurality of electric wires 42 disposed in the plurality of second disposition grooves 2t. Specifically, the second lid member 7 has, for example, a plate shape. The second lid member 7 includes a second facing surface 7a and a plurality of second facing grooves 7b. The second facing surface 7a is a flat surface intersecting the Z-axis direction. The second facing surface 7a faces the second disposition surface 2n. When viewed from the Z-axis direction, the second facing surface 7a overlaps with the plurality of second disposition grooves 2t. When viewed from the Z-axis direction, the outer edge of the second facing surface 7a overlaps with the outer edge of the second disposition surface 2n.

The plurality of second facing grooves 7b are formed on the second facing surface 7a. The plurality of second facing grooves 7b are arranged along the X-axis direction. The second facing groove 7b extends along the Y-axis direction and is open to both end surfaces of the second lid member 7 in the Y-axis direction. The second facing groove 7b has, for example, a semicircular shape when viewed from the Y-axis direction. The interval between the second facing grooves 7b adjacent to each other is the same as the interval between the second disposition grooves 2t adjacent to each other. The second facing groove 7b is open in the same direction as the second facing surface 7a. The second facing groove 7b and the second disposition groove 2t are plane-symmetrical with respect to a plane parallel to the XY plane. Tip portions of the electric wire 41 and the electric wire 42 are disposed in a space formed by the second disposition groove 2t and the second facing groove 7b in a state of being exposed from the cover 43. That is, the tip portions of the electric wire 41 and the electric wire 42 are covered with the ferrule 2 and the second lid member 7.

Each of the first lid member 6 and the second lid member 7 is fixed to the ferrule 2 by, for example, interference fit or press fitting. Each of the first lid member 6 and the second lid member 7 may be fixed to the ferrule 2 by, for example, an adhesive or the like. The dielectric constant of each of the first lid member 6 and the second lid member 7 is the same as the dielectric constant of the ferrule 2. In the present embodiment, the material of each of the first lid member 6 and the second lid member 7 is the same as the material of the ferrule 2. The material of each of the ferrule 2, the first lid member 6, and the second lid member 7 is, for example, resin or the like. Specifically, the material of each of the ferrule 2, the first lid member 6, and the second lid member 7 is, for example, polyetherimide (PEI), polyphenylene sulfide (PPS), polycarbonate (PC), polymethyl methacrylate (PMMA), polyethersulfone (PES), or the like.

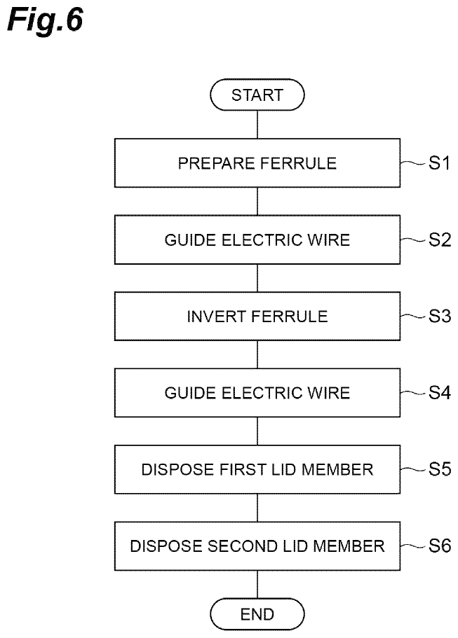

Next, a method for manufacturing the electrical connector 1 will be described. FIG. 6 is a flow chart of a method for manufacturing the electrical connector 1. As illustrated in FIG. 6, first, the ferrule 2 described above is prepared in a first step S1. Subsequently, in a second step S2, each electric wire 31 and each electric wire 32 are disposed in the first disposition groove 2s and guided to the front-end surface 2d. In the second step S2, after each electric wire 31 and each electric wire 32 are inserted into the first insertion hole 2f with the guidance of the first disposition groove 2s, the tip of each electric wire 31 and each electric wire 32 is guided until reaching the front-end surface 2d.

Subsequently, in a third step S3, the ferrule 2 is inverted. In the third step S3, the ferrule 2 is inverted in a state where each electric wire 31 and each electric wire 32 are inserted into the first insertion hole 2f. Subsequently, in a fourth step S4, each electric wire 41 and each electric wire 42 are disposed in the second disposition groove 2t and guided to the front-end surface 2d. In the fourth step S4, after each electric wire 41 and each electric wire 42 are inserted into the second insertion hole 2g with the guidance of the second disposition groove 2t, the tip of each electric wire 41 and each electric wire 42 is guided until reaching the front-end surface 2d.

Subsequently, in a fifth step S5, the first lid member 6 is disposed on the first disposition surface 2m such that the plurality of electric wire 31 and the plurality of electric wire 32 are covered with the first lid member 6. In the fifth step S5, the first lid member 6 is fixed to the ferrule 2 by, for example, interference fit or the like. Subsequently, in a sixth step S6, the second lid member 7 is disposed on the second disposition surface 2n such that the plurality of electric wires 41 and the plurality of electric wires 42 are covered with the second lid member 7. In the sixth step S6, the second lid member 7 is fixed to the ferrule 2 by, for example, interference fit or the like.

In this manner, in the electrical connector 1, the ferrule 2 includes the plurality of first disposition grooves 2s, and the plurality of electric wires 31 and the plurality of electric wires 32 are disposed in the plurality of first disposition grooves 2s. This makes it possible to guide the electric wires 31 and 32 to the front-end surface 2d in a state of being disposed in the first disposition groove 2s. In addition, since the first lid member 6 is disposed on the first disposition surface 2m in such a manner as to cover the plurality of electric wires 31 and the plurality of electric wires 32, the non-uniformity of the dielectric constant distribution around the electric wires 31 and 32 is suppressed as compared with, for example, a case where the region of the electric wires 31 and 32 on the side opposite to the first disposition groove 2s is exposed to air. This makes is possible to suppress deterioration in communication performance due to impedance mismatch. Thus, according to the electrical connector 1, it is possible to easily guide the electric wires 31 and 32 to the front-end surface 2d and to suppress deterioration in communication performance.

Similarly, the plurality of electric wires 41 and the plurality of electric wires 42 are disposed in the plurality of second disposition grooves 2t, and the second lid member 7 is disposed on the second disposition surface 2n in such a manner as to cover the plurality of electric wires 41 and the plurality of electric wires 42 disposed in the plurality of second disposition grooves 2t. This makes it possible to guide the electric wires 41 and 42 to the front-end surface 2d in a state of being disposed in the second disposition groove 2t. In addition, since the second lid member 7 is disposed on the second disposition surface 2n in such a manner as to cover the plurality of electric wires 41 and the plurality of electric wires 42, the non-uniformity of the dielectric constant distribution around the electric wires 41 and 42 is suppressed as compared with, for example, a case where the region of the electric wires 41 and 42 on the side opposite to the second disposition groove 2t is exposed to air. This makes is possible to suppress deterioration in communication performance due to impedance mismatch. Thus, according to the electrical connector 1, it is possible to easily guide the electric wires 41 and 42 to the front-end surface 2d and to suppress deterioration in communication performance.

The ferrule 2 includes a plurality of first insertion holes 2f communicating with the plurality of first disposition grooves 2s and opening to the front-end surface 2d, and a plurality of second insertion holes 2g communicating with the plurality of second disposition grooves 2t and opening to the front-end surface 2d. The electric wires 31 and 32 are inserted into the first insertion holes 2f, and the electric wires 41 and 42 are inserted into the second insertion holes 2g. This configuration secures the positional accuracy of the electric wires 31 and 32 and the positional accuracy of the electric wires 41 and 42.

The dielectric constant of each of the first lid member 6 and the second lid member 7 is the same as the dielectric constant of the ferrule 2. This makes it possible to reliably suppress the non-uniformity of the dielectric constant distribution around the electric wires 31 and 32 and reliably suppress the non-uniformity of the dielectric constant distribution around the electric wires 41 and 42.

The plurality of electric wires 31 and the plurality of electric wires 32 are a plurality of electric wires of a first flexible flat cable (first cable 3). The plurality of electric wires 41 and the plurality of electric wires 42 are a plurality of electric wires of a second flexible flat cable (second cable 4). This makes it possible to suppress deterioration in communication performance of each flexible flat cable.

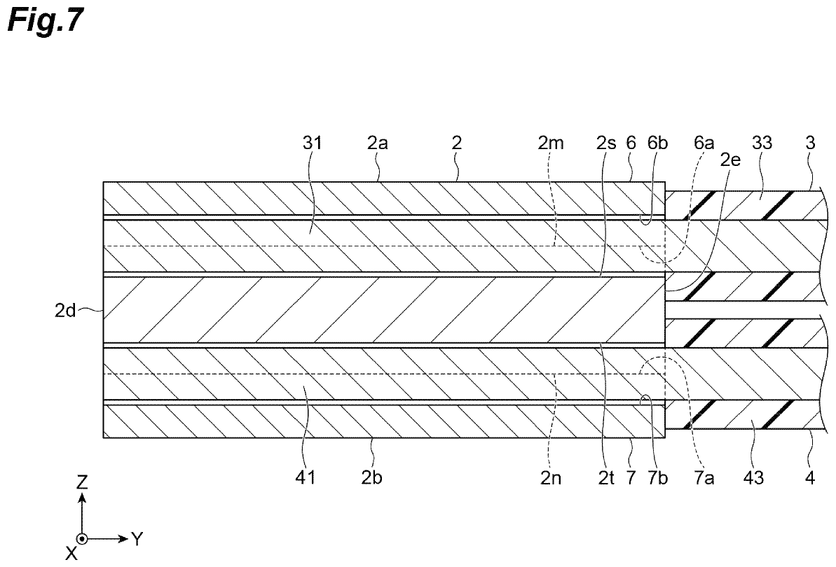

In the method for manufacturing the electrical connector 1, in the second step S2, the plurality of electric wires 31 and the plurality of electric wires 32 are disposed in the plurality of first disposition grooves 2s and the plurality of electric wires 31 and the plurality of electric wires 32 are guided to the front-end surface 2d, in the third step S3, the ferrule 2 is reversed, and in the fourth step S4, the plurality of electric wires 41 and the plurality of electric wires 42 are disposed in the plurality of second disposition grooves 2t and the plurality of electric wires 41 and the plurality of electric wires 42 are guided to the front-end surface 2d. This makes it possible to easily guide the electric wires 31, 32, 41, and 42 to the front-end surface 2d. Further, in the fifth step S5, the first lid member 6 is disposed on the first disposition surface 2m in such a manner as to cover the plurality of electric wires 31 and the plurality of electric wires 32, and in the sixth step S6, the second lid member 7 is disposed on the second disposition surface 2n in such a manner as to cover the plurality of electric wires 41 and the plurality of electric wires 42. With this configuration, as described above, the non-uniformity of the dielectric constant distribution around the electric wires 31, 32, 41, and 42 is suppressed, and thus deterioration in communication performance due to impedance mismatch is suppressed. Thus, according to this manufacturing method, it is possible to easily guide the electric wires 31, 32, 41, and 42 to the front-end surface 2d and to suppress deterioration in communication performance.

[Modification] FIG. 7 is a sectional view of an electrical connector according to a modification. As illustrated in FIG. 7, the first disposition surface 2m may extend to the front-end surface 2d. The first disposition groove 2s may extend to the front-end surface 2d and open to the front-end surface 2d. That is, the ferrule 2 does not have to include the first main surface 2a. In this case, when viewed from the Z-axis direction, the first lid member 6 overlaps with the plurality of first disposition grooves 2s, and the outer edge of the first facing surface 6a of the first lid member 6 overlaps with the outer edge of the first disposition surface 2m. Similarly, the second disposition surface 2n may extend to the front-end surface 2d. The second disposition groove 2t may extend to the front-end surface 2d and open to the front-end surface 2d. That is, the ferrule 2 does not have to include the second main surface 2b. In this case, when viewed from the Z-axis direction, the second lid member 7 overlaps with the plurality of second disposition grooves 2t, and the outer edge of the second facing surface 7a of the second lid member 7 overlaps with the outer edge of the second disposition surface 2n.

In the embodiment, an example is shown in which the dielectric constant of each of the first lid member 6 and the second lid member 7 is the same as the dielectric constant of the ferrule 2, but the dielectric constant of each of the first lid member 6 and the second lid member 7 may be different from the dielectric constant of the ferrule 2. The dielectric constant of each of the first lid member 6 and the second lid member 7 may be smaller than the dielectric constant of the ferrule 2 or larger than the dielectric constant of the ferrule 2.

In the embodiment, an example is shown in which the material of each of the first lid member 6 and the second lid member 7 is the same as the material of the ferrule 2, but the material of each of the first lid member 6 and the second lid member 7 may be different from the material of the ferrule 2. The materials of the first lid member 6 and the second lid member 7 may be different from each other. The material of each of the first lid member 6 and the second lid member 7 may be, for example, polybutylene terephthalate (PBT) or the like.

The electrical connector 1 does not have to include any one of the first lid member 6 and the second lid member 7.

The fifth step S5 may be performed after the second step S2 and before the third step S3.

What is claimed is:

1. An electrical connector comprising:
a ferrule including a front-end surface intersecting a first direction, a first disposition surface parallel to the first direction, and a plurality of first disposition grooves extending along the first direction and formed on the first disposition surface in such a manner as to be arranged along a second direction intersecting the first direction;
a plurality of first electric wires disposed in the plurality of first disposition grooves; and
a first lid member disposed on the first disposition surface,
wherein the first lid member covers the plurality of first electric wires disposed in the plurality of first disposition grooves.

2. The electrical connector according to claim 1, further comprising:
a plurality of second electric wires; and a second lid member,
wherein the ferrule further includes a second disposition surface facing a side opposite to the first disposition surface, and a plurality of second disposition grooves extending along the first direction and formed in the second disposition surface in such a manner as to be arranged along the second direction,
the plurality of second electric wires are disposed in the plurality of second disposition grooves, and
the second lid member is disposed on the second disposition surface in such a manner as to cover the plurality of second electric wires disposed in the plurality of second disposition grooves.

3. The electrical connector according to claim 2,
wherein the ferrule further includes a plurality of first insertion holes communicating with the plurality of first disposition grooves and opening to the front-end surface, and a plurality of second insertion holes communicating with the plurality of second disposition grooves and opening to the front-end surface,
the plurality of first electric wires are inserted into the plurality of first insertion holes, and
the plurality of second electric wires are inserted into the plurality of second insertion holes.

4. The electrical connector according to claim 2, wherein the plurality of first disposition grooves and the plurality of second disposition grooves extend to the front-end surface.

5. The electrical connector according to claim 2,
wherein at least one electric wire of the plurality of first electric wires functions as a working electrode,
at least one electric wire of the plurality of first electric wires functions as a ground electrode,
at least one electric wire of the plurality of second electric wires functions as a working electrode,
at least one electric wire of the plurality of second electric wires functions as a ground electrode.

6. The electrical connector according to claim 5,
wherein the electric wire of the plurality of first electric wires functions as the working electrode and the electric wire of the plurality of second electric wires functions as the working electrode are arranged along a third direction intersecting the second direction when viewed from the first direction, and
the electric wire of the plurality of first electric wires functions as the ground electrode and the electric wire of the plurality of second electric wires functions as the ground electrode are arranged along the third direction.

7. The electrical connector according to claim 2, wherein a dielectric constant of each of the first lid member and the second lid member is the same as a dielectric constant of the ferrule.

8. The electrical connector according to claim 7, wherein a material of each of the first lid member and the second lid member is the same as a material of the ferrule.

9. The electrical connector according to claim 2,
wherein the plurality of first electric wires are a plurality of electric wires of a first flexible flat cable, and
the plurality of second electric wires are a plurality of electric wires of a second flexible flat cable.

10. A method for manufacturing an electrical connector, the method comprising:
a first step of preparing a ferrule including a front-end surface intersecting a first direction, a first disposition surface parallel to the first direction, a plurality of first disposition grooves extending along the first direction and formed on the first disposition surface in such a manner as to be arranged along a second direction intersecting the first direction, a second disposition surface facing a side opposite to the first disposition surface, and a plurality of second disposition grooves extending along the first direction and formed on the second disposition surface in such a manner as to be arranged along the second direction;
a second step of disposing a plurality of first electric wires in the plurality of first disposition grooves and guiding the plurality of first electric wires to the front-end surface;
a third step of inverting the ferrule;
a fourth step of disposing a plurality of second electric wires in the plurality of second disposition grooves and guiding the plurality of second electric wires to the front-end surface;
a fifth step of disposing a first lid member on the first disposition surface in such a manner as to cover the plurality of first electric wires; and
a sixth step of disposing a second lid member on the second disposition surface in such a manner as to cover the plurality of second electric wires.
